(19) United States
(12) Patent Application Publication
(10) Pub. No.: US 2010/0330492 A1
(43) Pub. Date: Dec. 30, 2010

(54) CARRIER FOR ELECTROSTATIC DEVELOPMENT, DEVELOPER FOR ELECTROSTATIC DEVELOPMENT, DEVELOPER CARTRIDGE FOR ELECTROSTATIC DEVELOPMENT, PROCESS CARTRIDGE AND IMAGE FORMING APPARATUS

(75) Inventors: Yosuke TSURUMI, Kanagawa (JP); Akihiro IIZUKA, Kanagawa (JP); Fusako KIYONO, Kanagawa (JP); Takeshi SHOJI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/622,073

(22) Filed: Nov. 19, 2009

(30) Foreign Application Priority Data
Jun. 25, 2009 (JP) 2009-151179

(51) Int. Cl. G03G 9/00; G03G 15/08

(52) U.S. Cl. 430/111.1; 399/252

(57) ABSTRACT

The invention provides a carrier for electrostatic development, including ferrite particles and a coating layer including a resin having a cycloalkyl group, the ferrite particles including strontium in an amount of from about 0.1% by weight to about 1.0% by weight and having a BET specific surface area of from about 0.13 m²/g to about 0.23 m²/g.

### CROSS-REFERENCE TO RELATED APPLICATION

This application based on and claims priority under 35 USC 119 from Japanese Patent Application No. 2009-151179 filed Jun. 25, 2009.

### BACKGROUND

1. Technical Field

The present invention relates to a carrier for electrostatic development, a developer for electrostatic development, a developer cartridge for electrostatic development, a process cartridge, and an image forming apparatus.

2. Related Art

Electrophotography is a technique of forming an image by developing an electrostatic latent image formed on the surface of an electrostatic latent image holding unit (photoreceptor) with a toner including a colorant, transferring the toner image to the surface of a recording medium, and then fixing the transferred toner image to the recording medium with a heat roller or the like. In this technique, cleaning or the like may be performed to remove toner remaining on the electrostatic latent image holding unit in order to form a new electrostatic latent image thereon. When there is almost no toner remaining on the electrostatic latent image holding unit, e.g., when a toner having a spherical shape is used, the cleaning process may be omitted. Dry developers, which are used in electrophotography or the like, are largely classified as one-component developers in which a toner formed by compounding a colorant or the like in a binder resin is included, or as two-component developers in which a toner and a carrier are mixed.

### SUMMARY

According to an aspect of the invention, there is provided a carrier for electrostatic development, including ferrite particles and a coating layer including a resin having a cycloalkyl group, the ferrite particles including strontium in an amount of from about 0.1% by weight to about 1.0% by weight and having a BET specific surface area of from about 0.13 m²/g to about 0.23 m²/g.

### BRIEF DESCRIPTION OF THE DRAWING

FIG. 1 is a schematic drawing showing an exemplary embodiment of an image forming apparatus according to the invention.

### DETAILED DESCRIPTION

### Carrier for Electrostatic Development

The carrier for electrostatic development according to an exemplary embodiment of the invention (hereinafter, referred to as a “carrier according to the present exemplary embodiment” sometimes) is formed from ferrite particles including strontium in an amount of from 0.1% by weight or about 0.1% by weight to 1.0% by weight or about 1.0% by weight, and having a BET specific surface area of from 0.13 m²/g or about 0.13 m²/g to 0.23 m²/g or about 0.23 m²/g; and a layer for coating the ferrite particles, the layer including a resin having a cycloalkyl group.

The carrier according to the present exemplary embodiment has been invented based on the findings that changes in charge amount can be suppressed by using ferrite particles including strontium in an amount of from 0.1% by weight or about 0.1% by weight to 1.0% by weight or about 1.0% by weight as a core material, and that this effect can be more remarkably achieved when the ferrite particles have a BET specific surface area of from 0.13 m²/g or about 0.13 m²/g to 0.23 m²/g or about 0.23 m²/g, and are coated by a layer including a resin having a cycloalkyl group.

Typically, when performing continuous printing at low print-image density, or when rotating a development unit without performing printing, under low-temperature and low-humidity conditions (for example, at 10° C. and 12% RH, hereinafter the same), the toner in the developer is less often replaced with a new toner. As a result, the carrier and the toner are excessively agitated, and the charge amount is increased. When the carrier according to the present exemplary embodiment is used, changes in charge amount due to agitation, or due to environmental changes (such as high temperature and high humidity (for example, at 30° C. and 33% RH, hereinafter the same) or low temperature and low humidity) can be suppressed. Specifically, when the carrier according to the present exemplary embodiment is used, a phenomenon that the charge amount is significantly increased (charge-up phenomenon) is less likely to occur, even when the carrier is exceedingly agitated at low-temperature and low-humidity conditions. The reason for this is thought to be as follows.

The reason why changes in charge amount can be suppressed by using ferrite particles including strontium in an amount of from 0.1% by weight to 1.0% by weight as a core material is thought to be as follows.

Since strontium has a low degree of first ionization energy and a large sum of the first ionization energy and the second ionization energy, relative to other materials that have been conventionally used for the ferrite particles, influences due to electric field transfer are small even though the electric field transfer with a resin that forms a coating layer is easily caused. This characteristic, i.e., suppressed influences due to electric field transfer, is thought to contribute to suppress the charge-up phenomenon. Further, since strontium is less likely to cause leakage of charges, the charge amount thereof is thought to be less likely to attenuate. As a result, for example, it is thought that changes in charge amount can be suppressed even when the level of agitation is changed from strong to weak.

In the present exemplary embodiment, the content of strontium in the ferrite particles can be measured using fluorescent X-rays. Specifically, as a pre-treatment, a prescribed amount of ferrite particles and a resin as an embedding material are press-molded at 10 t for one minute using a press-molder, and are measured using a fluorescent X-ray measurement device (SRF-1500, trade name, manufactured by Shimadzu Corporation). The measurement is conducted at a tube voltage of 49 kV, a tube current of 90 mA, and a measurement time of 30 minutes. The resin used as an embedding material is preferably a resin fowled only from carbon, hydrogen and oxygen, such as cellulose, polyvinyl alcohol, or high-melting-point polyethylene.

Based on the results obtained by the above measurement, a calibration curve of strontium is obtained and the content of strontium in the ferrite particles is quantitatively measured based on the obtained calibration curve.

The reason why changes in charge amount due to agitation can be suppressed by coating the aforementioned ferrite particles with a coating layer including a resin having a cycloalkyl group is thought to be as follows.

The resin having a cycloalkyl group has a small degree of polarity and is less likely to involve in charge exchange with a toner. As a result, a charge-up phenomenon is thought to be less likely to occur. Further, when the resin having a cycloalkyl group contacts ferrite particles including strontium, charges generated in the resin are transferred to the ferrite particles, which are less susceptible to influences of electric field transfer, even when the resin having a cycloalkyl group is charged. Therefore, it is thought that the charge-up phenomenon is less likely to occur even when the developer is exceedingly agitated. Moreover, since a cycloalkyl group is highly hydrophobic, it is thought that the carrier is less susceptible to moisture by having a coating layer including the resin having a cycloalkyl group.

In addition, when the ferrite particles has a BET specific surface area of from 0.13 m²/g to 0.23 m²/g, an appropriate contact area of the coating layer and the ferrite particles is ensured and, as a result, it is thought that the transfer of charges at an interface of the coating layer and the ferrite particles tends to be active, thereby enhancing the effect of suppressing changes in charge amount. The BET specific surface area of the ferrite particles as mentioned here is a value as measured by a nitrogen-substitution method using a BET specific surface area measurement device (FLOWSORB II 2300, trade name, manufactured by Shimadzu Corporation).

(Ferrite Particles)

The ferrite particles according to the present exemplary embodiment include strontium in an amount of from 0.1% by weight or about 0.1% by weight to 1.0% by weight or about 1.0% by weight, and have a BET specific surface area of from 0.13 m²/g or about 0.13 m²/g to 0.23 m²/g or about 0.23 m²/g. The ferrite is a substance typically expressed by the following Formula (1). In Formula (1), X and Y each represent a molar ratio based on weight, and X+Y=100.

(MO)_{X}(Fe₂O₃)_{Y} Formula (1)

In Formula (1), M represents a metal including at least strontium, and typically represents an alloy of strontium and a metal other than strontium. Exemplary metals other than strontium are not particularly limited, and include lithium, magnesium, calcium, manganese, and tin. One or more kinds of metal other than strontium may be included in the alloy in combination with strontium.

The content of strontium in the ferrite particles is from 0.1% by weight or about 0.1% by weight to 1.0% by weight or about 1.0% by weight, more preferably from 0.4% by weight to 0.8% by weight, yet more preferably from 0.5% by weight to 0.6% by weight. When the content of strontium in the ferrite particles is from 0.1% by weight or about 0.1% by weight to 1.0% by weight or about 1.0% by weight, transfer of charges at an interface of the resin having a cycloalkyl group and the ferrite particles may moderately occur. On the other hand, when the content of strontium in the ferrite particles is less than 0.1% by weight or about 0.1% by weight, the transfer of charges may not occur to a sufficient degree, and when the content of strontium in the ferrite particles exceeds 1.0% by weight or about 1.0% by weight, the transfer of charges may exceed an appropriate degree and fogging of a toner may occur.

The ferrite particles have a specific surface area of from 0.13 m²/g or about 0.13 m²/g to 0.23 m²/g or about 0.23 m²/g, preferably from 0.15 m²/g to 0.20 m²/g, more preferably from 0.16 m²/g to 0.18 m²/g. When the BET specific surface area is less than 0.13 m²/g or about 0.13 m²/g, the transfer of charges at an interface of the resin having a cycloalkyl group and the ferrite particles may be interrupted, and an effect of suppressing changes in charge amount due to agitation may not be achieved. As a result, fogging or degradation in image density tends to occur. On the other hand, when the BET specific surface area exceeds 0.20 m²/g or about 0.20 m²/g, the charge-imparting ability of carrier particles may not be uniform due to the variation in thickness of the coating layer, thereby causing fogging of a toner.

The ferrite particles are typically produced by forming particles from a metal oxide or a metal salt as a raw material, and then sintering the same. The BET specific surface area of the ferrite particles according to the present exemplary embodiment can be adjusted to a range of from 0.13 m²/g or about 0.13 m²/g to 0.23 m²/g or about 0.23 m²/g by performing pre-sintering, pulverization, granulation, and main-sintering.

The following is an exemplary method of producing the ferrite particles according to the present exemplary embodiment.

A pre-sintered product is obtained by mixing a powder of a metal oxide or a metal salt as a raw material, and pre-sintering the same using a rotary kiln or the like. Exemplary metal oxides or metal salts as a raw material include Fe₂O₃, MnO₂, SrCO₃, and Mg(OH)₂. For example, the content of strontium can be adjusted to a range of from 0.1% by weight to 1.0% by weight by controlling the amount of SrCO₃.

The temperature for the pre-sintering may be from 800° C. to 1000° C., for example, and the time for the pre-sintering may be from 6 hours to 10 hours, for example.

The thus obtained pre-sintered product is pulverized by a known method, i.e., by adding polyvinyl alcohol, water, a surfactant and a deforming agent to the pre-sintered product, and then pulverizing the mixture in a mortar, a ball mill, a jet mill, or the like. The pulverization is performed until the average diameter of the particles is from 4 μm to 10 μm, for example.

The pulverized pre-sintered product is granulated and dried using a spray drier. The dried pre-sintered product is then subjected to further pre-sintering (second pre-sintering) to remove organic materials contained therein, thereby obtaining a secondary pre-sintered product. The temperature for the secondary pre-sintering may be from 800° C. to 1000° C., for example, and the time for the pre-sintering may be from 5 hours to 10 hours, for example.

To the obtained secondary pre-sintered product, polyvinyl alcohol, water, a surfactant and a deforming agent are added, and the mixture is pulverized in a mortar, a ball mill, a jet mill, or the like. The pulverization is performed until the average diameter of the particles is from 4 μm to 8 μm, for example. The pulverized secondary pre-sintered product is then granulated and dried using a spray drier.

The granulated product after being dried is subjected to main-sintering using a rotary kiln, thereby obtaining a main-sintered product. The temperature for the main-sintering may be from 1000° C. to 1400° C., for example, and the time for the main-sintering may be from 3 hours to 6 hours, for example.

The main-sintered product is then subjected to pulverization and classification, thereby obtaining ferrite particles.

The average particle diameter of the obtained ferrite particles may be, for example, from 30 μm or about 30 μm to 50 μm or about 50 μm. The average particle diameter of the sintered product or the ferrite particles is a value as measured by a laser deffraction/scattering particle size analyzer (LS PARTICLE SIZE ANAYZER, LS13 320, trade name, manufactured by Beckman Coulter, Inc.) In this method, the obtained particle size distribution is divided into particle size ranges (channels), and a number-based accumulation distribution is drawn from the smaller particle size side. A particles size at an accumulation of 50% in the accumulation distribution is determined as the number average volume average 50% particle size.

(Coating Layer)

The carrier according to the present exemplary embodiment has a coating layer that coats the aforementioned ferrite particles, and the coating layer includes a resin having a cycloalkyl group.

Examples of the resin having a cycloalkyl group include: (1) a homopolymer of a monomer having a cycloalkyl group; (2) a copolymer of two or more kinds of monomer having a cycloalkyl group; and (3) a copolymer of a monomer having a cycloalkyl group and a monomer having no cycloalkyl group.

In the above cases (1) to (3), the cycloalkyl group may be, for example, a 3 to 10-membered ring. Specific examples thereof include a cyclohexyl group, a cyclopentyl group, a cyclopropyl group, a cyclobutyl group, a cycloheptyl group, a cyclooctyl group, a cyclononyl group, and a cyclodecyl group. Among these, a cyclohexyl group and a cyclopentyl group are preferred.

Exemplary resins having a cycloalkyl group include a cycloalkyl acrylic acid resin, a cycloalkyl methacrylic acid resin, a cycloalkyl methacrylate-methacrylate copolymer, a cycloalkylacrylate-methacrylate copolymer, a cycloalkyl methacrylate-acrylate copolymer, a copolymer of any combination of cycloalkyl acrylate, cycloalkyl methacrylate, acrylate and methacrylate, a copolymer of cycloalkyl methacrylate and styrene, a copolymer of cycloalkyl acrylate and styrene, a polyester resin having a cycloalkyl group in a side chain, a urethane resin having a cycloalkyl group in a side chain, and a urea resin having a cycloalkyl group in a side chain.

In particular, the resin having a cycloalkyl group is preferably (3) a copolymer of a monomer having a cycloalkyl group and a monomer having no cycloalkyl group, more preferably a copolymer of at least one of cycloalkyl acrylate or cycloalkyl methacrylate and at least one of methyl methacrylate or methacrylate, further preferably a copolymer of cycloalkyl acrylate and at least one of methyl methacrylate or methacrylate. When the resin having a cycloalkyl group is a copolymer of cycloalkyl acrylate and at least one of methyl methacrylate or methacrylate, suppression of changes in charge amount can be maintained. This effect is thought to be due to the improved adhesion between the coating layer and the ferrite particles.

The copolymerization ratio in a copolymer of at least one of cycloalkyl acrylate or cycloalkyl methacrylate and at least one of methyl methacrylate or methacrylate (at least one of cycloalkyl acrylate or cycloalkyl methacrylate: at least one of methyl methacrylate or methacrylate, molar ratio) may be, for example, from 85:15 or about 85:15 to 99:1 or about 99:1.

Further, the weight average molecular weight of the resin having a cycloalkyl group may be, for example, from 3,000 or about 3,000 to 200,000 or about 200,000.

The above molecular weight is measured by gel permeation chromatography (GPC), using a GPC measuring device (HLC-8120GPC, SC-8020, trade name, manufactured by Tosoh Corporation), two columns of TSKgel, Super HM-H (trade name, manufactured by Tosoh Corporation, 6.0 mm ID×15 cm), and THF (tetrahydrofuran) as an eluent. The measurement is conducted under conditions of a sample concentration of 0.5%, a flow rate of 0.6 ml/min, a sample injection amount of 10 μl, and a measurement temperature of 40° C., using an IR detector. The calibration curve is obtained from ten samples (polystyrene reference samples, TSK Standard, A-500, F-1, F-10, F-80, F-380, A-2500, F-4, F-40, F-128 and F-700, manufactured by Tosoh Corporation).

The carrier according to the present exemplary embodiment may include conductive particles (particles having a volume resistivity at 20° C. of 1×10⁻⁶ Ωcm or less) dispersed in the coating layer. Exemplary conductive particles include, but not limited thereto, metals such as gold, silver and copper, carbon black, titanium oxide, zinc oxide, barium sulfate, aluminum borate, potassium titanate, and tin oxide.

The coating ratio of the coating layer with respect to the ferrite particles is preferably 97% or more or about 97% or more. The coating ratio can be measured by the following method.

The carrier is fixed on a sample holder, and this is inserted in a chamber of an X-ray photoelectron spectroscopy measuring device (ESCA-9000MX, trade name, manufactured by JEOL Ltd.) The vacuum in the chamber is controlled to 10×10⁻⁶ Pa or less, Mg-Kα is used as an exitation source, and the output is set at 200 W. Under these conditions, XPS spectra of the magnetic particles and the carrier are measured, and the coating ratio is calculated from the ratio of area intensity at an Fe peak (2p3/2) of detected electrons, in accordance with the following expression (F1 is a Fe area intensity of the magnetic particles, and F2 is an Fe area intensity of the carrier).

Coating Ratio=(F2/F1×100)

One example of the method for coating a surface of ferrite particles with a resin is a method using a solution for forming a coating layer, the solution including a resin having a cycloalkyl group as mentioned above and optional additives that are dissolved in an appropriate solvent.

More specifically, the above process may be conducted by an immersion method in which the ferrite particles are immersed in the solution for forming a coating layer, a spray method in which the solution for forming a coating layer is sprayed on the ferrite particles, and a kneader-coater method in which the ferrite particles and the solution for forming a coating layer are mixed in a kneader-coater, and then the solvent is removed.

<Developer for Electrostatic Development>

The developer for electrostatic development according to the present exemplary embodiment (hereinafter, referred to as a “developer according to the present exemplary embodiment”) is a so-called two-component developer including a toner and the carrier according to the present exemplary embodiment as mentioned above. In the following, the toner used in the present exemplary embodiment is described.

The toner used in the present exemplary embodiment is not particularly limited, but includes at least a binder resin, a colorant, and a release agent.

The toner used in the present exemplary embodiment may be, for example, a toner prepared through a process of dispersing particles of a binder resin and a colorant in an aqueous dispersing medium; a process of allowing the dispersed particles of a binder resin and a colorant to aggregate using metal ions; a process of further adding only particles of a binder resin to cause additional aggregation; and a process of fusing the aggregated particles by heating the same. It is also possible to use a toner obtained by a kneading-pulverizing method, in which a mixture of a binder resin, a colorant, an optional release agent, a charge control agent or the like is kneaded, pulverized and classified, or a toner obtained by modifying the shape of the particles obtained by a kneading-pulverizing method by a mechanical impact or thermal energy, in the present exemplary embodiment.

Exemplary binder resins for the toner used in the present exemplary embodiment include known binder resins, such as polyester, polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, and polypropylene. Further examples include polyester, polyurethane, epoxy resin, silicone resin, polyamide, modified rosin, and paraffin wax.

Exemplary colorants and release agents for the toner used in the present exemplary embodiment include known colorants and release agents.

Exemplary colorants include magnetic powders such as magnetite or ferrite, carbon black, aniline blue, calco oil blue, chromium yellow, ultramarine blue, DuPont oil red, quinoline yellow, methylene blue chloride, phthalocyanine blue, malachite green oxalate, lamp black, rose bengal, C. I. Pigment Red 48:1, C. I. Pigment Red 122, C. I. Pigment Red 57:1, C. I. Pigment Yellow 97, C. I. Pigment Yellow 17, C. I. Pigment Blue 15:1, and C. I. Pigment Blue 15:3.

Exemplary release agents include low-molecular polyethylene, low-molecular polypropylene, Fisher-Tropsh wax, montan wax, carnauba wax, rice wax, and cancelilla wax.

As necessary, the toner used in the present exemplary embodiment may include a known charge control agent, such as an azo-based metal complex compound, a metal complex compound of salicylic acid, and a resin-type charge control agent having a polar group.

Further, the toner used in the present exemplary embodiment may be added with an external additive such as silica, titanium oxide, metatitanic acid, aluminum oxide, magnesium oxide, alumina, barium titanate, magnesium titanate, calcium titanate, strontium titanate, zinc oxide, chromium oxide, antimony trioxide, magnesium oxide, and zirconium oxide.

The toner and the carrier included in the developer according to the present exemplary embodiment are mixed at a ratio of from 1:100 to 30:100 (toner:carrier, weight ratio), for example.

<Developer Cartridge for Electrostatic Development, Process Cartridge, and Image Fainting Apparatus>

The developer cartridge for electrostatic development according to the present exemplary embodiment (hereinafter, referred to as a “cartridge according to the present exemplary embodiment”) is removably attachable to an image forming apparatus, and includes therein the developer according to the present exemplary embodiment as mentioned above. By using this cartridge, the developer according to the present exemplary embodiment is supplied to a development unit in the image formation device. Therefore, as mentioned later, changes in charge amount of the developer can be suppressed even when the developer is excessively agitated in the development unit.

The image forming apparatus according to the present exemplary embodiment includes an electrostatic latent image holding unit, a charging unit that charges a surface of the electrostatic latent image holding unit, an electrostatic latent image formation unit that forms an electrostatic latent image on the surface of the electrostatic latent image holding unit, a development unit that forms a toner image by developing the electrostatic latent image with the developer according to the present exemplary embodiment, a transfer unit that transfers the toner image to a recording medium, and a fixing unit that fixes the toner image to the recording medium.

The process cartridge according to the present exemplary embodiment includes a development unit that accommodates the developer according to the present exemplary embodiment and forms a toner image by developing an electrostatic latent image formed on the surface of an electrostatic latent image holding unit, and at least one selected from the group consisting of an electrostatic latent image holding unit, a charging unit that charges the surface of the electrostatic latent image holding unit, and a cleaning unit that removes the toner remaining on the surface of the electrostatic latent image holding unit.

Typically, when the developer is agitated under low-temperature and low-humidity conditions, the charge amount of the toner is increased. In particular, when performing printing with less discharge amount of the toner, such as text printing, a large amount of the toner continues to be agitated in the development unit without being discharged therefrom. Further, when an image of a black color is printed using an image forming apparatus for forming a multicolor image using multiple electrostatic latent image holding units and development units, the amount of developers of other colors than black to be used is small, and these developers contain a large amount of toner that continues to be agitated without being discharged from the development unit.

The toner that continues to be agitated in the development unit has a high degree of charge amount, thereby being difficult to be developed. Therefore, when the toner having a high degree of charge amount is used, development is typically performed while adjusting the parameters in the image forming apparatus.

On the other hand, under high-temperature and high-humidity conditions, the toner is difficult to be charged due to moisture. Therefore, when an image forming apparatus is transferred from low-temperature and low-humidity conditions to high-temperature and high-humidity conditions and then left to stand for a while, the charge amount of the toner is decreased due to moisture. The degree of decrease in charge amount is more significant in the case of a toner having a higher degree of charge amount under low-temperature and low-humidity conditions. However, when printing is performed with a printer in which the parameters are adjusted to conform to a toner having a high degree of charge amount under low-temperature and low-humidity conditions, using a toner whose charge amount has been decreased due to the high-temperature and high-humidity conditions but not changing the parameters, fogging of the toner tends to occur due to the charge amount of the toner being too low. This phenomenon occurs particularly significantly when the development unit is rotated without discharging toner under low-temperature and low-humidity conditions (for example, development units of other colors than black in an image forming apparatus for forming a multicolor image).

However, since the process cartridge and the image forming apparatus according to the present exemplary embodiment employ the developer according to the present exemplary embodiment with suppressed changes in charge amount, occurrence of fogging can be suppressed even when the process cartridge or the image forming apparatus is transferred from low-temperature and low-humidity conditions to high-temperature and high-humidity conditions and then left to stand for a while.

In the following, the image forming apparatus according to the present exemplary embodiment is explained with reference to the drawings.

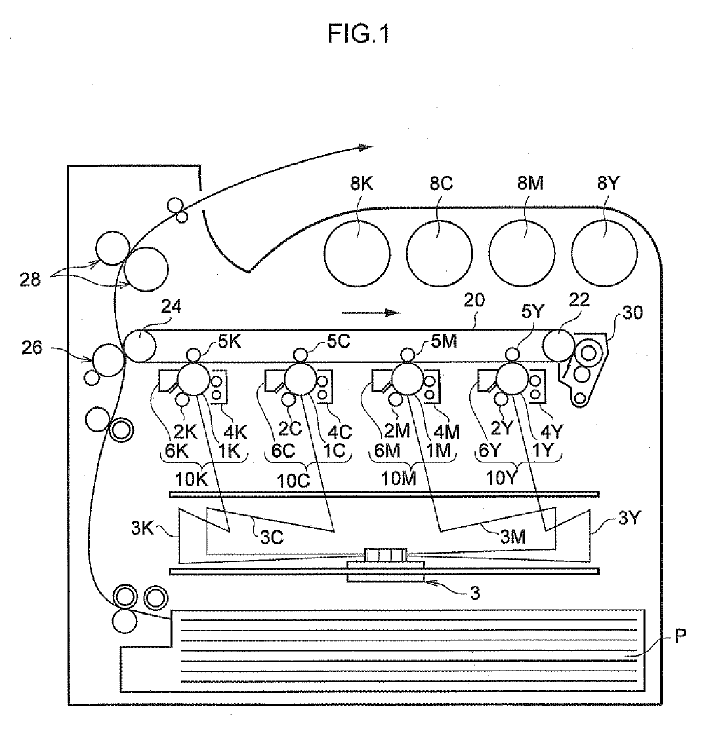

FIG. 1 is a schematic drawing showing an example of the image forming apparatus according to the present exemplary embodiment (a color image forming apparatus employing a four-series tandem system). The image forming apparatus shown in FIG. 1 includes four electrophotographic image formation units 10Y, 10M, 10C and 10K (image formation units) that form an image of yellow (Y), magenta (M), cyan (C) and black (K), respectively, in accordance with the color-separated image data. These image formation units (hereinafter, simply referred to as a “unit”) 10Y, 10M, 10C and 10K are arranged in a horizontal direction with a space therebetween. These units 10Y, 10M, 10C and 10K may be a process cartridge that is removably attachable to the main body of image forming apparatus.

In FIG. 1, an intermediate transfer belt 20 that serves as an intermediate transfer unit is positioned so as to extend over units 10Y, 10M, 10C and 10K. Intermediate transfer belt 20 is supported by a drive roller 22 and a support roller 24, which are positioned apart from each other, from the inside of intermediate transfer belt 20, and moves in a direction from the first unit 10Y to the fourth unit 10K. Support roller 24 is urged by a spring or the like (not shown) in a direction away from drive roller 22 so that a tension is applied to intermediate transfer belt 20 supported by these rollers. A cleaning unit 30 is positioned at the image holding unit side of intermediate transfer belt 20, facing drive roller 22.

Developers of yellow, magenta, cyan and black are accommodated in developer cartridges 8Y, 8M, 8C and 8K, respectively, and these developers are supplied to development units 4Y, 4M, 4C and 4K included in units 10Y, 10M, 10C and 10K, respectively.

Since units 10Y, 10M, 10C and 10K have substantially the same configuration in this exemplary embodiment, first unit 10Y that forms a yellow image and positioned upstream in a direction in which the intermediate transfer belt move is described below as a representative example. Explanations about second to fourth units 10M, 10C and 10K are omitted by assigning referential marks of magenta (M), cyan (C) or black (K) to a portion equivalent to first unit 10Y, respectively.

First unit 10Y includes a photoreceptor 1Y that functions as an electrostatic latent image holding unit. On the periphery of photoreceptor 1Y, a charging roller (charging unit) 2Y that charges the surface of photoreceptor 1Y, an exposure unit 3 that exposes the charged surface of photoreceptor 1Y to laser beams 3Y in accordance with color-separated image signals and forms an electrostatic latent image, a development unit 4Y that supplies charged toner to the electrostatic latent image and develops the electrostatic latent image with the toner, a primary transfer roller 5Y (primary transfer unit) that transfers the developed toner image onto the intermediate transfer belt 20, and a cleaning unit 6Y that removes the toner remaining on the surface of photoreceptor 1Y after the primary transfer, are arranged in this order.

In addition, a primary transfer roller 5Y is positioned inside the intermediate transfer belt 20, at a position opposite to photoreceptor 1Y. The primary transfer roller 5Y is connected to a bias power source (not shown) that applies a primary transfer bias thereto. The bias power source is controlled by a control unit (not shown) that can change the transfer bias applied to the primary transfer roller.

Hereinafter, the operation of forming a yellow image of the first unit 10Y is explained. First, prior to the operation, the surface of the photoreceptor 1Y is charged with the charging roller 2Y to have an electric potential of about −800V to −600V.

The photoreceptor 1Y includes a photosensitive layer formed on a substrate having conductivity (volume resistivity at 20° C.: 1×10⁻⁶ Ωcm or less). This photosensitive layer has a high degree of resistance (i.e., a resistance equivalent of that of a resin of ordinary type) in its ordinary state. However, the photosensitive layer has such a characteristic that a value of specific resistance changes at a portion irradiated with laser beam 3Y. Accordingly, when the surface of charged photoreceptor 1Y is irradiated with laser beam 3Y from an exposure device 3 in accordance with image data for a yellow image sent from a control section (not shown), an electrostatic latent image having a yellow print pattern is formed on the surface of photoreceptor 1Y.

In development unit 4Y, for example, a yellow toner including a yellow colorant and a binder resin, and a carrier (the carrier according to the present exemplary embodiment) are accommodated. The yellow toner is agitated in development unit 4Y so as to be triboelectrically charged to have the same polarity as that of the charges on photoreceptor 1Y, and is placed on a developer roller (developer holding unit). When the surface of photoreceptor 1Y passes development unit 4Y, the yellow toner is electrostatically attached to the discharged latent image formed on the surface of photoreceptor 1Y, and the latent image is developed with the yellow toner. Then, photoreceptor 1Y on which the yellow toner image is formed continues to move to convey the toner image formed on photoreceptor 1Y to a primary transfer position.

When the yellow toner image formed on photoreceptor 1Y is conveyed to the primary transfer position, a primary transfer bias is applied to the primary transfer roller 5Y, and an electrostatic force in a direction of from photoreceptor 1Y to primary transfer roller 5Y acts on the toner image. Then, the toner image formed on photoreceptor 1Y is transferred to intermediate transfer belt 20. The transfer bias applied at this time has the polarity (+) that is opposite to the polarity (−) of the toner, and is controlled to a degree of about +10 μA by a control unit (not shown) in first unit 10Y, for example.

On the other hand, the toner remaining on photoreceptor 1Y is removed and collected by a cleaning device 6Y.

The yellow toner as mentioned above forms a developer together with the carrier according to the present exemplary embodiment. Therefore, changes in charge amount due to agitation or environmental changes can be suppressed.

The primary transfer bias applied to each of primary transfer rollers 5M, 5C and 5K in units 10M, 10C and 10K is also controlled in a similar manner to first unit 10Y.

Intermediate transfer belt 20 to which a yellow toner image has been transferred in first unit 10Y moves to pass second to fourth units 10M, 10C and 10K, at which a toner image of each color is sequentially transferred so as to overlap each other.

Then, intermediate transfer belt 20 on which the toner image formed of overlapping toner images of four colors has been transferred moves to a secondary transfer section. The secondary transfer section includes intermediate transfer belt 20, support roller 24 that contacts the inner surface of intermediate transfer belt 20, and a secondary transfer roller (secondary transfer unit) 26 positioned at the image holding side of intermediate transfer belt 20. On the other hand, a recording medium P is supplied by a supply system to a portion at which secondary transfer roller 26 and intermediate transfer belt 20 contact each other with pressure, and a secondary transfer bias is applied to support roller 24. At this time, the polarity (−) of the transfer bias to be applied is the same as the polarity (−) of the toner, and an electrostatic force in a direction from intermediate transfer belt 20 toward recording medium P acts on the toner image. As a result, the toner image formed on intermediate transfer belt 20 is transferred to recording medium P. At this time, the secondary transfer bias is determined in accordance with the resistance detected by a resistance detection unit (not shown) that detects the resistance at the secondary transfer section, and is controlled by a voltage.

Thereafter, recording medium P is conveyed to a fixing device (fixing unit) 28, and the overlapping toner images are heated and fused so as to fix to recording medium P. After the fixation of the color image, recording medium P is conveyed to a discharge section and discharged, thereby completing the color image formation operation.

Although the image forming apparatus as illustrated in the above transfers a toner image to recording medium P using intermediate transfer belt 20, the structure of the image forming apparatus is not limited thereto, and a toner image may be transferred to recording medium P directly from the photoreceptor.

### Examples

Hereinafter, the invention will be described in detail with reference to the Examples, but the invention is not limited thereto. In the Examples, “part” and “%” each refer to “part by weight” and “% by weight”, unless otherwise specified.

<Preparation of Ferrite Particles>

(Preparation of Ferrite Particles 1)

As the raw materials, 74 parts of Fe₂O₃, 4 parts of Mg(OH)₂, 21 parts of Mn₂O₃ and 1 part of SrCO₃ are mixed and subjected to first pre-sintering at 900° C. for 7 hours in a rotary kiln, thereby obtaining a pre-sintered product 1. The obtained pre-sintered product 1 is pulverized in a wet-type ball mill for 7 hours so as to have an average particle diameter of 2.0 μm. Thereafter, the resultant is granulated and dried using a spray drier, and is further subjected to second pre-sintering at 950° C. for 6 hours in a rotary kiln, thereby obtaining a pre-sintered product 2. The obtained pre-sintered product 2 is pulverized in a wet-type ball mill for 5 hours so as to have an average particle diameter of 5.6 μm. Thereafter, the resultant is granulated and dried using a spray drier, and is then subjected to main-sintering at 1300° C. for 5 hours in an electric furnace. After subjecting the resultant to pulverization and classification, ferrite particles 1 having an average particle diameter of 36 μm are obtained. The BET specific surface area of the obtained ferrite particles 1 is 0.14 m²/g, and the content of strontium included therein is 0.6%.

(Preparation of Ferrite Particles 2)

Ferrite particles 2 having an average particle diameter of 36 μm are obtained in a similar manner to the preparation of ferrite particles 1, except that the pre-sintered product 2 is pulverized in a wet-type ball mill for 6 hours so as to have an average particle diameter of 5 μm, and the main sintering is performed for 4 hours. The BET specific surface area of the obtained ferrite particles 2 is 0.18 m²/g, and the content of strontium included therein is 0.6%.

(Preparation of Ferrite Particles 3)

Ferrite particles 3 having an average particle diameter of 35 μm are obtained in a similar manner to the preparation of ferrite particles 1, except that the pre-sintered product 2 is pulverized in a wet-type ball mill for 8 hours so as to have an average particle diameter of 4.9 μm, and that the main sintering is performed at 1280° C. for 4.5 hours. The BET specific surface area of the obtained ferrite particles 3 is 0.21 m²/g, and the content of strontium included therein is 0.6%.

(Preparation of Ferrite Particles 4)

Ferrite particles 4 having an average particle diameter of 36 μm are obtained in a similar manner to the preparation of ferrite particles 1, except that 74 parts of Fe₂O₃, 4.5 parts of Mg(OH)₂, 20 parts of Mn₂O₃ and 1.5 parts of SrCO₃ are used as the raw materials, and that the main sintering is performed at 1290° C. for 5 hours. The BET specific surface area of the obtained ferrite particles 4 is 0.14 m²/g, and the content of strontium included therein is 0.9%.

(Preparation of Ferrite Particles 5)

Ferrite particles 5 having an average particle diameter of 36 μm are obtained in a similar manner to the preparation of ferrite particles 4, except that the pre-sintered product 2 is pulverized in a wet-type ball mill for 6 hours so as to have an average particle diameter of 5.1 μm, and that the main sintering is performed at 1290° C. for 4 hours. The BET specific surface area of the obtained ferrite particles 5 is 0.18 m²/g, and the content of strontium included therein is 0.9%.

(Preparation of Ferrite Particles 6)

Ferrite particles 6 having an average particle diameter of 35 μm are obtained in a similar manner to the preparation of ferrite particles 4, except that the pre-sintered product 2 is pulverized in a wet-type ball mill for 8 hours so as to have an average particle diameter of 4.9 μm, and that the main sintering is performed at 1270° C. for 4 hours. The BET specific surface area of the obtained ferrite particles 6 is 0.21 m²/g, and the content of strontium included therein is 0.9%.

(Preparation of Ferrite Particles 7)

Ferrite particles 7 having an average particle diameter of 36 μm are obtained in a similar manner to the preparation of ferrite particles 1, except that 74 parts of Fe₂O₃, 4.7 parts of Mg(OH)₂, 21 parts of Mn₂O₃ and 0.35 parts of SrCO₃ are used as the raw materials, and that the main sintering is performed at 1310° C. for 5 hours. The BET specific surface area of the obtained ferrite particles 7 is 0.14 m²/g, and the content of strontium included therein is 0.2%.

(Preparation of Ferrite Particles 8)

Ferrite particles 8 having an average particle diameter of 36 μm are obtained in a similar manner to the preparation of ferrite particles 7, except that the pre-sintered product 2 is pulverized in a wet-type ball mill for 6 hours so as to have an average particle diameter of 5 μm, and that the main sintering is performed at 1300° C. for 5 hours. The BET specific surface area of the obtained ferrite particles 8 is 0.18 m²/g, and the content of strontium included therein is 0.2%.

(Preparation of Ferrite Particles 9)

Ferrite particles 9 having an average particle diameter of 36 μm are obtained in a similar manner to the preparation of ferrite particles 7, except that the pre-sintered product 2 is pulverized in a wet-type ball mill for 8 hours so as to have an average particle diameter of 4.9 μm, and that the main sintering is performed at 1290° C. for 4 hours. The BET specific surface area of the obtained ferrite particles 9 is 0.21 m²/g, and the content of strontium included therein is 0.2%.

(Preparation of Ferrite Particles 10)

Ferrite particles 10 having an average particle diameter of 37 μm are obtained in a similar manner to the preparation of ferrite particles 1, except that the pre-sintered product 2 is pulverized in a wet-type ball mill for 2 hours so as to have an average particle diameter of 6 μm, and that the main sintering is performed at 1300° C. for 4 hours. The BET specific surface area of the obtained ferrite particles 10 is 0.11 m²/g, and the content of strontium included therein is 0.6%.

(Preparation of Ferrite Particles 11)

Ferrite particles 11 having an average particle diameter of 36 μm are obtained in a similar manner to the preparation of ferrite particles 1, except that the pre-sintered product 2 is pulverized in a wet-type ball mill for 8 hours so as to have an average particle diameter of 4.9 μm, and that the main sintering is performed at 1250° C. for 4 hours. The BET specific surface area of the obtained ferrite particles 11 is 0.26 m²/g, and the content of strontium included therein is 0.6%.

(Preparation of Ferrite Particles 12)

Ferrite particles 12 having an average particle diameter of 36 μm are obtained in a similar manner to the preparation of ferrite particles 1, except that 70 parts of Fe₂O₃, 4 parts of Mg(OH)₂, 21 parts of Mn₂O₃ and 5 parts of SrCO₃ are used as the raw materials, that the pre-sintered product 2 is pulverized in a wet-type ball mill for 8 hours so as to have an average particle diameter of 4.9 μm, and that the main sintering is performed at 1290° C. for 4 hours. The BET specific surface area of the obtained ferrite particles 12 is 0.17 m²/g, and the content of strontium included therein is 3.1%.

(Preparation of Ferrite Particles 13)

Ferrite particles 13 having an average particle diameter of 36 μm are obtained in a similar manner to the preparation of ferrite particles 12, except that 75 parts of Fe₂O₃, 4 parts of Mg(OH)₂ and 21 parts of Mn₂O₃ are used as the raw materials. The BET specific surface area of the obtained ferrite particles 13 is 0.14 m²/g, and the content of strontium included therein is 0%.

(Preparation of Ferrite Particles 14)

Ferrite particles 14 having an average particle diameter of 36 μm are obtained in a similar manner to the preparation of ferrite particles 1, except that 20 parts of Mn₂O₃ and 2 parts of SrCO₃ are used as the raw materials, that the pre-sintered product 2 is pulverized in a wet-type ball mill for 6 hours so as to have an average particle diameter of 5 μm, and that the main sintering is performed at 1310° C. The BET specific surface area of the obtained ferrite particles 14 is 0.14 m²/g, and the content of strontium included therein is 1.2%.

<Preparation of Solution for Coating Layer>

(Preparation of Solution for Coating Layer 1)

A solution for coating layer 1 having a solid content concentration of 11% is prepared by mixing and agitating the following components together with glass beads (diameter: 1 mm, same amount as toluene) in a sand mill (manufactured by Kansai Paint Co., Ltd.) for 30 minutes at a rotation rate of 1,200 rpm.

| | |
|---|---|
| Cyclohexyl methacrylate-methyl methacrylate copolymer | 36 parts |
| (molar ratio of cyclohexyl methacrylate:methyl meth- | |
| acrylate = 90:10, weight average molecular weight: 60,000) | |
| Carbon black (VXC 72, trade name, manufactured by Cabot | 4 parts |
| Corporation) | |
| Toluene (manufactured by Wako Pure Chemical Industries, | 500 parts |
| Ltd.) | |
| Isopropyl alcohol (manufactured by Wako Pure Chemical | 50 parts |
| Industries, Ltd.) | |

(Preparation of Solution for Coating Layer 2)

A solution for coating layer 2 having a solid content concentration of 11% is prepared by mixing and agitating the following components together with glass beads (diameter: 1 mm, same amount as toluene) in a sand mill (manufactured by Kansai Paint Co., Ltd.) for 30 minutes at a rotation rate of 1,200 rpm.

| | |
|---|---|
| Styrene-cyclohexyl methacrylate copolymer (molar ratio of | 36 parts |
| styrene:cyclohexyl methacrylate = 84:16, weight average | |
| molecular weight: 100,000) | |
| Carbon black (VXC 72, trade name, manufactured by Cabot | 4 parts |
| Corporation) | |
| Toluene (manufactured by Wako Pure Chemical Industries, | 500 parts |
| Ltd.) | |
| Isopropyl alcohol (manufactured by Wako Pure Chemical | 50 parts |
| Industries, Ltd.) | |

<Preparation of Carrier>

(Preparation of Carrier 1)

2,000 parts of ferrite particles 1 are placed in a 5 L vacuum deairing-type kneader, and 360 parts of solution for coating layer 1 is further added thereto. While agitating the content, the temperature is increased and the pressure is reduced. Then, agitation is continued at 90° C. and −720 mHg for 30 minutes and dried, thereby obtaining particles having a coating. The obtained particles are classified using a 75 μm-mesh sieve, and carrier 1 is thus obtained.

(Preparation of Carrier 2)

Carrier 2 is obtained in a similar manner to the preparation of carrier 1, except that ferrite particles 2 are used instead of ferrite particles 1, and that the amount of solution for coating layer 1 is changed to 450 parts.

(Preparation of Carrier 3)

Carrier 3 is obtained in a similar manner to the preparation of carrier 1, except that ferrite particles 3 are used instead of ferrite particles 1, and that the amount of solution for coating layer 1 is changed to 450 parts.

(Preparation of Carrier 4)

Carrier 4 is obtained in a similar manner to the preparation of carrier 1, except that ferrite particles 4 are used instead of ferrite particles 1.

(Preparation of Carrier 5)

Carrier 5 is obtained in a similar manner to the preparation of carrier 1, except that ferrite particles 5 are used instead of ferrite particles 1, and that the amount of solution for coating layer 1 is changed to 450 parts.

(Preparation of Carrier 6)

Carrier 6 is obtained in a similar manner to the preparation of carrier 1, except that ferrite particles 6 are used instead of ferrite particles 1, and that the amount of solution for coating layer 1 is changed to 450 parts.

(Preparation of Carrier 7)

Carrier 7 is obtained in a similar manner to the preparation of carrier 1, except that ferrite particles 7 are used instead of ferrite particles 1.

(Preparation of Carrier 8)

Carrier 8 is obtained in a similar manner to the preparation of carrier 1, except that ferrite particles 8 are used instead of ferrite particles 1, and that the amount of solution for coating layer 1 is changed to 450 parts.

(Preparation of Carrier 9)

Carrier 9 is obtained in a similar manner to the preparation of carrier 1, except that ferrite particles 9 are used instead of ferrite particles 1, and that the amount of solution for coating layer 1 is changed to 450 parts.

(Preparation of Carrier 10)

Carrier 10 is obtained in a similar manner to the preparation of carrier 1, except that ferrite particles 2 are used instead of ferrite particles 1, and that solution for coating layer 2 is used instead of solution for coating layer 1.

(Preparation of Carrier 11)

Carrier 11 is obtained in a similar manner to the preparation of carrier 1, except that ferrite particles 10 are used instead of ferrite particles 1.

(Preparation of Carrier 12)

Carrier 12 is obtained in a similar manner to the preparation of carrier 1, except that ferrite particles 11 are used instead of ferrite particles 1, and that the amount of solution for coating layer 1 is changed to 450 parts.

(Preparation of Carrier 13)

Carrier 13 is obtained in a similar manner to the preparation of carrier 1, except that ferrite particles 12 are used instead of ferrite particles 1, and that the amount of solution for coating layer 1 is changed to 450 parts.

(Preparation of Carrier 14)

Carrier 14 is obtained in a similar manner to the preparation of carrier 1, except that ferrite particles 13 are used instead of ferrite particles 1.

(Preparation of Carrier 15)

Carrier 15 is obtained in a similar manner to the preparation of carrier 1, except that ferrite particles 14 are used instead of ferrite particles 1.

<Preparation of Toner>

(Preparation of Resin Particle Dispersion 1)

The following components are placed in a flask and the temperature is increased to 200° C. over 1 hour. After confirming that the reaction system is uniformly agitated, 1.2 parts of dibutyltin oxide are added therein. The temperature is further increased to 240° C. over 6 hours while removing water generated during the reaction, and at this temperature the dehydration-condensation reaction is allowed to continue for another 4 hours. A polyester resin having an acid value of 9.4 mgKOH/g, a weight average molecular weight of 13,000, and a glass transition temperature of 62° C. is thus obtained.

| | |
|---|---|
| Ethylene glycol (manufactured by Wako Pure Chemical | 37 parts |
| Industries, Ltd.) | |
| Neopentyl glycol (manufactured by Wako Pure Chemical | 65 parts |
| Industries, Ltd.) | |
| 1,9-nonanediol (manufactured by Wako Pure Chemical | 32 parts |
| Industries, Ltd.) | |
| Terephthalic acid (manufactured by Wako Pure Chemical | 96 parts |
| Industries, Ltd.) | |

The obtained polyester resin in a molten state is transferred to a disperser (CAVITRON CD 1010, trade name, manufactured by Eurotec, Ltd.) at a rate of 100 g/minute. On the other hand, a diluted ammonia water having a concentration of 0.37% by weight is prepared by diluting reagent ammonia water with ion exchange water, and is placed in an aqueous medium tank. The diluted ammonia water is transferred to the disperser at a rate of 0.1 liter/minute while heating the same to 120° C., together with the molten polyester resin. The disperser is operated by rotating the rotor at 60 Hz at a pressure of 5 kg/cm². A dispersion (resin particle dispersion 1) having an average particle diameter of 160 nm, a solid content concentration of 30%, a glass transition temperature of 62° C., and a weight average molecular weight (Mw) of 13,000 is thus obtained.

(Preparation of Colorant Particle Dispersion)

The following components are mixed and dispersed using a high-pressure collision-type ultimizer (HP 30006, trade name, manufactured by Sugino Machine Limited) for 1 hour, and a colorant particle dispersion having a volume average particle size of 180 nm and a solid content concentration of 20% is thus obtained.

| | |
|---|---|
| Cyan pigment (PIGMENT BLUE 15:3, trade name, | 10 parts |
| manufactured by Dainichiseika Color & Chemicals | |
| Mfg. Co., Ltd.) | |
| Anionic surfactant (NEOGEN SC, trade name, | 2 parts |
| manufactured by Dai-ichi Kogyo Seiyaku Co., Ltd.) | |
| Ion exchange water | 80 parts |

(Preparation of Binder Resin 1)

The following components are placed in a flask and the temperature is increased to 160° C. over 1 hour. After confirming that the reaction system is uniformly agitated, 0.03 parts of dibutyltin oxide are added therein. The temperature is further increased to 200° C. over 6 hours while removing water generated during the reaction, and at this temperature the dehydration-condensation reaction is allowed to continue for another 4 hours. After the completion of reaction, the reaction solution is cooled and subjected to solid-liquid separation. The obtained solid is dried at 40° C. under vacuum, thereby obtaining a binder resin 1.

| | |
|---|---|
| Decanedioic acid (manufactured by Tokyo Chemical | 81 parts |
| Industry Co., Ltd.) | |
| Hexanediol (manufactured by Wako Pure Chemical | 47 parts |
| Industries, Ltd.) | |

The melting point of binder resin 1 as measured by using a differential scanning calorimeter (DSC-7, trade name, manufactured by PerkinElmer Co., Ltd.) is 64° C. The weight average molecular weight as measured by using a molecular weight measuring device (HLC-8020, trade name, manufactured by Tosoh Corporation) and tetrahydrofuran (THF) as a solvent is 15,000.

(Preparation of Binder Resin 2)

The following components are heated to 120° C. and thoroughly dispersed using a disperser (ULTRA TURRAX T50, trade name, manufactured by IKA Japan K.K.), and then subjected to a dispersing treatment using a pressure ejection-type homogenizer. The resultant is recovered when the volume average particle size thereof is 180 nm. A resin particle dispersion 2 having a solid content concentration of 20% is thus obtained.

| | |
|---|---|
| Binder resin 1 | 50 parts |
| Anionic surfactant (NEOGEN SC, trade name, manufactured | 2 parts |
| by Dai-ichi Kogyo Seiyaku Co., Ltd.) | |
| Ion exchange water | 200 parts |

(Preparation of Release Agent Particle Dispersion)

The following components are heated to 120° C. and thoroughly dispersed using a disperser (ULTRA TURRAX T50, trade name, manufactured by IKA Japan K.K.), and then subjected to a dispersing treatment using a pressure ejection-type homogenizer. A release agent particle dispersion having a volume average particle size of 200 nm and a solid content concentration of 20% is thus obtained.

| | |
|---|---|
| Paraffin wax (HNP-9, trade name, manufactured by | 50 parts |
| Nippon Seiro Co., Ltd.) | |
| Anionic surfactant (NEOGEN SC, trade name, | 2 parts |
| manufactured by Dai-ichi Kogyo Seiyaku Co., Ltd.) | |
| Ion exchange water | 200 parts |

(Preparation of Toner 1)

The following components are thoroughly mixed and dispersed in a round stainless flask, using a disperser (ULTRA TURRAX T50, trade name, manufactured by IKA Japan K.K.). Then, the content of the flask is heated to 48° C. using an oil bath while stirring. After maintaining the content at 48° C. for 60 minutes, 70 parts of resin particle dispersion 1 (same composition as below) is gradually added thereto.

| | | |
|---|---|---|
| Resin particle dispersion 1 | 150 | parts |
| Colorant particle dispersion | 25 | parts |
| Release agent particle dispersion | 35 | parts |
| Resin particle dispersion 2 | 50 | parts |
| Polyaluminum chloride | 0.4 | parts |
| Ion exchange water | 100 | parts |

Thereafter, the pH in the system is adjusted to 8.0 using an aqueous solution of sodium hydroxide (0.5 mol/L), and the flask is sealed. The flask is heated and maintained at 90° C. for 30 minutes while agitating with a magnetic stirrer. After the completion of reaction, the temperature is decreased at a rate of 5° C./minute, and the resultant is filtered and thoroughly washed with ion exchange water, and then subjected to solid-liquid separation by a Nutsche suction filtration method. This is further dispersed in 3 L of ion exchange water (30° C.), and stirred and washed for 15 minutes at 300 rpm. This washing process is performed six more times. When the filtrate exhibits a pH of is 7.54 and a conductivity of 6.5 μS/cm, this is subjected to solid-liquid separation by a Nutsche suction filtration method using a No. 5A filter. Thereafter, vacuum-drying is performed for 24 hours in a consecutive manner, thereby obtaining a toner.

The volume average particle size (D50v) of the obtained toner as measured by using a Coulter counter is 5.7 μm.

Further, fine particles of silica (SiO₂) having an average primary particle diameter of 40 nm, whose surface having been subjected to hydrophobic treatment with hexamethyl disilazane (HMDS), and fine particles of a metatitanic acid compound having an average primary particle diameter of 20 nm, which is a reaction product of metatitanic acid and isobutyl trimethoxysilane, are added to the obtained toner so as to coat the surface of the toner at a coating ratio of 40%, and the resultant is mixed using a Henschel mixer. The average particle size distribution indexes (GSDv) of the above fine particles are 1.20, respectively. A toner for electrostatic development 1 is thus obtained.

### Example 1

A developer including carrier 1 and toner 1 at a weight ratio of 100:6 is placed in a development unit for a cyan developer and a development unit for a black developer installed in a printing machine (DOCU CENTRE COLOR 400, trade name, manufactured by Fuji Xerox Co., Ltd., modified such that the development units for multicolor/yellow/magenta/cyan are rotated when only a black color is printed), and the printing machine is left to stand at 10° C. and 12% RH for 12 hours. Thereafter, a solid patch of 10 cm×10 cm is formed 1,000 times in a consecutive manner, using the black development unit. Subsequently, a solid patch of 10 cm×10 cm is formed using the cyan development unit, and this image is determined as C0. Then, the printing machine is left to stand at 30° C. and 88% RH for 12 hours. Thereafter, another solid patch of 10 cm×10 cm is formed using the cyan development unit, and this image is determined as C1 .

Since the image C0 is formed when the charge amount is easily increased, using a toner that has been agitated without being replaced with a new toner, the image is difficult to be developed and the density thereof tends to decrease. On the other hand, since the image C1 is formed when the charge amount is easily decreased under high-temperature and high-humidity conditions, fogging is easily caused by the toner attaching to the background.

Subsequently, the printing machine is transferred to an environment of 10° C. and 12% RH, and is left to stand for 12 hours. Thereafter, a solid patch of 10 cm×10 cm is formed 10,000 times in a consecutive manner, using the cyan development unit, and the 10,000th image is determined as C2. Then, the printing machine is placed in an environment of 30° C. and 88% RH, and is left to stand for 12 hours. Thereafter, a solid patch of 10 cm×10 cm is formed using the cyan development unit, and this image is determined as C3 .

The image C2 indicates the degree of stability in charge amount of the carrier under the condition that the toner is replaced with a new toner, wherein the reduction in density and fogging tend to occur at the same time, since the charge amount of the carrier tends to decrease due to the attachment of the toner and a certain degree of charge amount cannot be secured. The image C3 indicates the degree of occurrence of fogging under the condition that the charge amount decreases even more easily.

(Evaluation of Fogging)

Occurrence of fogging in the images C1 to C3 is evaluated in accordance with the following criteria, and the results are shown in Table 1.

The decrease in density is evaluated in a relative manner with respect to the density of the cyan image that is formed after the formation of 1,000 images using the black development unit. The results graded A to C are determined as a tolerable level, respectively.

A: An image of an excellent quality with substantially no decrease in density or fogging is formed.

B: An image with a slight degree of fogging or decrease in density is formed, but an excellent quality thereof is maintained when visually observed with a microscope.

C: An image with fogging or decrease in density is formed, but the quality thereof is within a tolerable level.

D: An image with an unacceptable level of fogging or decrease in density is formed.

### Example 2

The evaluation is conducted in a similar manner to Example 1, except that carrier 2 is used instead of carrier 1. The results are shown in Table 1.

### Example 3

The evaluation is conducted in a similar manner to Example 1, except that carrier 3 is used instead of carrier 1. The results are shown in Table 1.

### Example 4

The evaluation is conducted in a similar manner to Example 1, except that carrier 4 is used instead of carrier 1. The results are shown in Table 1.

### Example 5

The evaluation is conducted in a similar manner to Example 1, except that carrier 5 is used instead of carrier 1. The results are shown in Table 1.

### Example 6

The evaluation is conducted in a similar manner to Example 1, except that carrier 6 is used instead of carrier 1. The results are shown in Table 1.

### Example 7

The evaluation is conducted in a similar manner to Example 1, except that carrier 7 is used instead of carrier 1. The results are shown in Table 1.

### Example 8

The evaluation is conducted in a similar manner to Example 1, except that carrier 8 is used instead of carrier 1. The results are shown in Table 1.

### Example 9

The evaluation is conducted in a similar manner to Example 1, except that carrier 9 is used instead of carrier 1. The results are shown in Table 1.

### Example 10

The evaluation is conducted in a similar manner to Example 1, except that carrier 10 is used instead of carrier 1. The results are shown in Table 1.

### Comparative Example 1

The evaluation is conducted in a similar manner to Example 1, except that carrier 11 is used instead of carrier 1. The results are shown in Table 1.

### Comparative Example 2

The evaluation is conducted in a similar manner to Example 1, except that carrier 12 is used instead of carrier 1. The results are shown in Table 1.

### Comparative Example 3

The evaluation is conducted in a similar manner to Example 1, except that carrier 13 is used instead of carrier 1. The results are shown in Table 1.

### Comparative Example 4

The evaluation is conducted in a similar manner to Example 1, except that carrier 14 is used instead of carrier 1, and that toner 2 is used instead of toner 1. The results are shown in Table 1.

### Comparative Example 5

The evaluation is conducted in a similar manner to Example 1, except that carrier 15 is used instead of carrier 1. The results are shown in Table 1.

TABLE 1

| | Carrier | | | | | | |
|---|---|---|---|---|---|---|---|
| | | Sr content | | | | | |
| | | in ferrite | BET specific | Evaluation of | | | |
| | | particles | surface area | fogging in images | | | |
| | No. | (%) | (m2/g) | C0 | C1 | C2 | C3 |
| Ex. 1 | 1 | 0.6 | 0.14 | A | A | A | B |
| Ex. 2 | 2 | 0.6 | 0.18 | A | A | A | A |
| Ex. 3 | 3 | 0.6 | 0.21 | A | A | A | B |
| Ex. 4 | 4 | 0.9 | 0.14 | A | A | B | C |
| Ex. 5 | 5 | 0.9 | 0.18 | A | A | A | B |
| Ex. 6 | 6 | 0.9 | 0.21 | A | A | B | C |
| Ex. 7 | 7 | 0.2 | 0.14 | A | A | B | C |
| Ex. 8 | 8 | 0.2 | 0.18 | A | A | A | B |
| Ex. 9 | 9 | 0.2 | 0.21 | A | A | B | C |
| Ex. 10 | 10 | 0.6 | 0.18 | A | A | A | B |
| Com. Ex. 1 | 11 | 0.6 | 0.11 | A | B | C | D |
| Com. Ex. 2 | 12 | 0.6 | 0.26 | A | B | C | D |
| Com. Ex. 3 | 13 | 3.1 | 0.17 | B | C | D | * |
| Com. Ex. 4 | 14 | 0.0 | 0.14 | A | B | C | D |
| Com. Ex. 5 | 15 | 1.2 | 0.14 | A | B | C | D |

* Evaluation is not conducted.

All publications, patent applications, and technical standards mentioned in this specification are herein incorporated by reference to the same extent as if each individual publication, patent application, or technical standard was specifically and individually indicated to be incorporated by reference.

What is claimed is:

1. A carrier for electrostatic development, comprising ferrite particles and a coating layer comprising a resin having a cycloalkyl group, the ferrite particles comprising strontium in an amount of from about 0.1% by weight to about 1.0% by weight and having a BET specific surface area of from about 0.13 m²/g to about 0.23 m²/g.

2. The carrier according to claim 1, wherein the ferrite particles have an average particle diameter of from about 30 μm to about 50 μm.

3. The carrier according to claim 1, wherein the resin having a cycloalkyl group comprises a copolymer formed from at least one of cycloalkyl acrylate or cycloalkyl methacrylate, and at least one of methyl methacrylate or methacrylate.

4. The carrier according to claim 3, wherein the copolymer has a copolymerization rate of the at least one of cycloalkyl acrylate or cycloalkyl methacrylate to the at least one of methyl methacrylate or methacrylate of from about 85:15 to about 99:1.

5. The carrier according to claim 3, wherein the cycloalkyl group is a 3 to 10-membered ring.

6. The carrier according to claim 3, wherein the resin having a cycloalkyl group has a weight average molecular weight of from about 3,000 to about 200,000.

7. The carrier according to claim 1, wherein the coating layer comprises conductive particles.

8. The carrier according to claim 1, wherein the coating layer coats the surface of the ferrite particles at a coating ratio of about 97% or more.

9. A developer for electrostatic development, comprising a toner and the carrier according to claim 1.

10. The developer according to claim 9, wherein the toner comprises a release agent.

11. The developer according to claim 10, wherein the release agent comprises a paraffin wax.

12. The developer according to claim 9, wherein the toner comprises silica and metatitanic acid as external additives.

13. A developer cartridge for electrostatic development, comprising the developer according to claim 9 and being detachably attached to an image-forming apparatus.

14. A process cartridge comprising a development unit and at least one selected from the group consisting of an electrostatic latent image holding unit, a charging unit that charges a surface of the electrostatic latent image holding unit, and a cleaning unit that removes toner remaining on the surface of the electrostatic latent image holding unit,
the development unit comprising the developer according to claim 9 and developing an electrostatic latent image formed on the surface of the electrostatic latent image holding unit, with the developer, to form a toner image.

15. An image forming apparatus comprising:
an electrostatic latent image holding unit;
a charging unit that charges a surface of the electrostatic latent image holding unit;
an electrostatic latent image forming unit that forms an electrostatic latent image on the surface of the electrostatic latent image holding unit;
a development unit that comprises the developer according to claim 9 and forms a toner image by developing the electrostatic latent image with the developer;
a transfer unit that transfers the toner image to a recording medium; and
a fixing unit that fixes the toner image to the recording medium.
